(19) United States
(12) Patent Application Publication
(10) Pub. No.: US 2026/0203067 A1
(43) Pub. Date: Jul. 16, 2026

(54) Prefetcher based on PC-relative Operations

(71) Applicant: Apple Inc., Cupertino, CA (US)

(72) Inventors: Srinivas Keshav, Austin, TX (US); Niket K. Choudhary, Santa Clara, CA (US); Eric J. Furbish, Austin, TX (US)

(21) Appl. No.: 19/018,977

(22) Filed: Jan. 13, 2025

(51) Int. Cl. G06F 9/38; G06F 9/30; G06F 12/0875

(52) U.S. Cl. CPC G06F 9/383; G06F 9/3804; G06F 12/0862

(57) ABSTRACT

Techniques are disclosed relating to prefetching in computer processors. In some embodiments, a processor executes load instructions that access data at an indicated address. Prefetch circuitry may generate prefetch requests to access data predicted to be utilized by load instructions, including to detect a set of one or more instructions that specify a PC-relative arithmetic operation, that depends on one or more immediate values in the one or more instructions, followed by a load operation. In response to the detection, the prefetch circuitry may perform the PC-relative arithmetic operation to determine a target address for the load operation and initiate a data prefetch to the determined target address.

### BACKGROUND

### Technical Field

This disclosure relates generally to computer processors and more particularly to data prefetching.

### Description of Related Art

Prefetchers typically prefetch data from memory (or other cache levels) into data caches closer to a processor, where the data can be accessed with lower latency, when needed. Therefore, prefetchers use various techniques to predict what data will be used in the future. Many prefetchers use pattern matching to detect certain patterns of memory accesses and predict the addresses of upcoming requests, then prefetch the data from those predicted addresses. Traditional prefetchers, however, may not perform well for certain patterns of instructions and may not prefetch for certain initial accesses while training.

### BRIEF DESCRIPTION OF DRAWINGS

FIG. 1 is a block diagram illustrating example PC-relative prefetch circuitry, according to some embodiments.

FIG. 2 is a diagram illustrating example address calculations for a prefetch based on an instruction sequence, according to some embodiments.

FIG. 3 is a block diagram illustrating example sequence detector circuitry, according to some embodiments.

FIG. 4 is a flow diagram illustrating example techniques for scanning sequences of instructions and determining when to launch a prefetch, according to some embodiments.

FIG. 5 is a block diagram illustrating example prefetch queue and load/store circuitry configured to handle prefetch requests initiated by the PC-relative prefetcher.

FIG. 6 is a flow diagram illustrating an example method, according to some embodiments.

FIG. 7 is a block diagram illustrating an example computing device, according to some embodiments.

FIG. 8 is a diagram illustrating example applications of disclosed systems and devices, according to some embodiments.

FIG. 9 is a block diagram illustrating an example computer-readable medium that stores circuit design information, according to some embodiments.

### DETAILED DESCRIPTION

Certain sequences of instructions may benefit from non-traditional prefetch techniques discussed herein. For example, one or more PC-relative arithmetic operations may operate on a program counter and immediate values (encoded in the instruction(s) themselves) followed by a load to an address output by the arithmetic operations. A traditional pattern match prefetcher may not perform well for these patterns. In disclosed embodiments, a prefetcher includes logic configured to detect such patterns, perform the arithmetic operations, and initiate a prefetch to the calculated address.

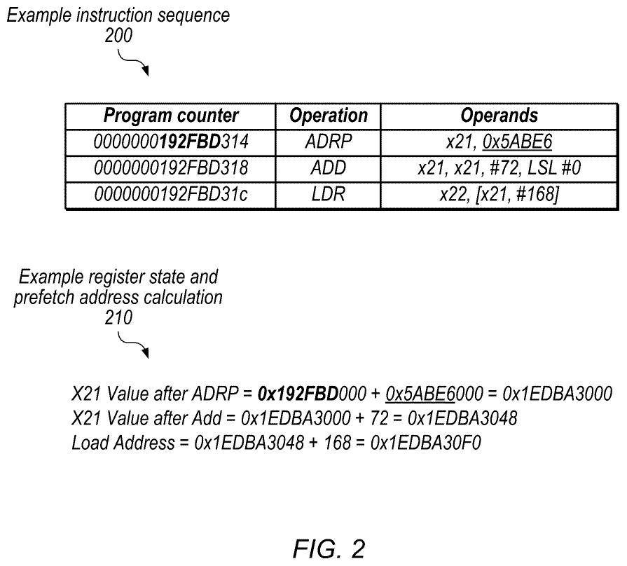

As one example pattern, consider an ADRP instruction, followed by an ADD that uses the result of the ADRP as an input, followed by an LDR that targets a location corresponding to the result of the ADD. In this example, the prefetcher may perform multiple add operations on immediate values in the pattern to determine the target of the LDR and prefetch the data. This example is discussed in detail below with reference to FIG. 2 (and the prefetcher may perform prefetches for multiple different patterns, also discussed below).

In some embodiments, control circuitry is configured to scan an instruction-cache-line worth of instructions (e.g., in response to an instruction cache fill) for instruction patterns and generate prefetches when matching instruction patterns are found. Some embodiments may detect multiple patterns within a given fill and may detect patterns across different beats of a fill.

Disclosed techniques may advantageously provide an accurate prefetch address early in processing of a load (e.g., on a fill into an instruction cache, before the load is fetched for execution). Disclosed techniques may also allow prefetching for accesses that typically would not have been detected by a pattern-based prefetcher. Similar techniques may also be used to prefetch targets for branch instructions that follow PC-relative instructions.

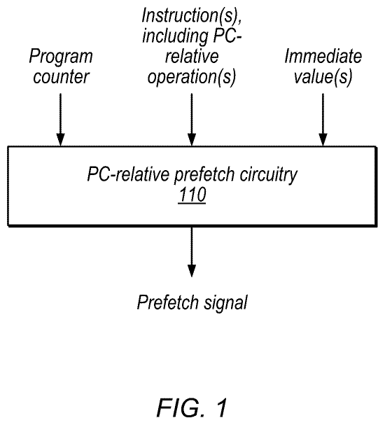

FIG. 1 is a block diagram illustrating example PC-relative prefetch circuitry, according to some embodiments. In the illustrated example, PC-relative prefetch circuitry 110 receives as inputs: the current program counter, one or more instructions that include PC-relative operation(s) (and potentially other operations that operate on immediate values), and one or more immediate values. In some embodiments, prefetch circuitry 110 performs the indicated operation(s) based on the program counter and the immediate value(s) to determine a prefetch address. Prefetch circuitry 110 generates a prefetch signal, e.g., to request or launch a prefetch to the determined address. Other circuitry may launch a prefetch to the requested address, to fetch memory into a data cache from another cache or a memory.

Note that the prefetch address itself may not be a prediction, because the address will be accurate if the instruction(s) are executed. The prefetch itself, however, may be predictive because the load may not actually be executed. Rather, prefetch circuitry 110 may generate prefetch signaling early, e.g., on a fill to an instruction cache before it is known with certainty whether the fill data will be utilized.

FIG. 2 is a diagram illustrating example address calculations for a prefetch based on an instruction sequence, according to some embodiments. Illustrated example instruction sequence 200 includes the following instructions: an ADRP, followed by an ADD, followed by an LDR. FIG. 2 also shows example register state and prefetch calculation values 210 (note that the register X21 is not actually updated for prefetch calculations, but the example values during execution of the sequence of instructions may match intermediate values during prefetch calculations, in some embodiments).

The ADRP specifies to add the immediate operand 0x5ABE6 (underlined in FIG. 2) to certain bits of the program counter (the bits 0x192FBD shown in bold in FIG. 2) and store the result in register X21. After execution of the ADRP instruction, the X21 register would store the result 0x1EDBA3000.

The ADD specifies to add seventy-two to the value of X21 and store the result in X21 (this example also specifies a left-shift of zero). After execution of the ADD instruction, the X21 register would store the result 0x1EDBA3048.

The LDR specifies to add one hundred and sixty-eight to the value in x21, load data from the resulting address, and store the load data in register X22. The resulting load address is 0x1EDBA30F0.

Prefetch circuitry 110, in some embodiments, includes arithmetic logic unit (ALU) circuitry configured to perform various operations, including operations on PC values and immediate values. As used herein, the term “immediate” is used according to its well-understood meaning, which includes values encoded directly in an instruction that are accessible based on only data in the instruction itself (e.g., without accessing a register or a memory location). Immediate values may be directly included in the instruction (e.g., as binary-encoded values) or may be encoded (e.g., quantized, one-hot encoded, etc.). In embodiments with encoded immediate operands, prefetch circuitry 110 may include decode circuitry configured to decode the immediate value before performing specified operations.

For example, prefetch circuitry 110 may include adder circuitry configured to add the program counter of the ADRP operation, the immediate value from the ADRP operation, the immediate value from the ADD operation, and the immediate value from the LDR operation. The prefetcher ALU circuitry may be configured to perform the operations in a single cycle or over multiple cycles. The prefetcher circuitry may be configured to perform the operations as a single operation (e.g., using adder circuitry that accepts up to N input operands where N is the greatest number of operand inputs supported for a pattern of instructions) or as multiple operations (e.g., using parallel adders or sequential operations using a given adder). Further, the ALU circuitry may support other operations in addition to, or in place of, add operations (e.g., shifts, multiplication, bit-wise logical operations, etc.).

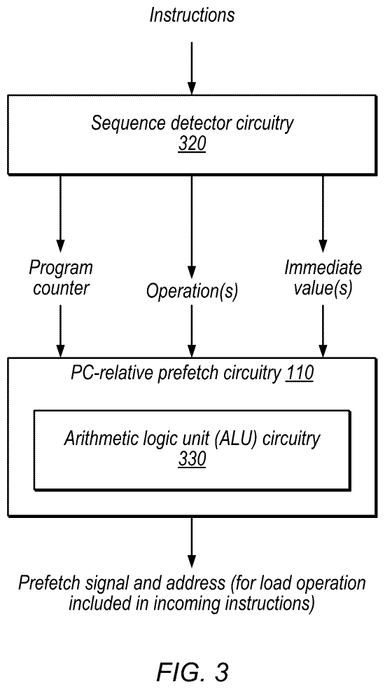

Note that prefetch circuitry 110 may support various instruction sequences of instructions and example sequence detector circuitry is discussed below with reference to FIG. 3. Example other patterns include, without limitation: ADRP/ADD/LD, ADR/LD, LDR, etc. In each of these instances, prefetch circuitry 110 may prefetch data for the last instruction in the sequence based on one or more operations that operate on a program counter and one or more immediate values.

Prefetch circuitry 110 may additionally or alternatively prefetch branch targets based on PC-relative operations, in some embodiments. For example, consider the instruction sequence ADRP/ADD/BRANCH. If the branch is an indirect branch, prefetch circuitry 110 may perform one or more arithmetic operations based on the program counter of the ADRP and immediate value(s) in the ADRP and ADD instructions to generate a target of the branch. Prefetch circuitry 110 may initiate a prefetch into an instruction cache of a set of instructions located at the branch target, in these embodiments. As shown by this example, the target prefetching may be based on a sequence of multiple instructions that ends with the branch. Disclosed target prefetching techniques may be utilized for conditional branches, unconditional branches, or both.

FIG. 3 is a block diagram illustrating example sequence detector circuitry, according to some embodiments. In the illustrated example, the processor includes PC-relative prefetch circuitry 110 and sequence detector circuitry 320. Prefetch circuitry 110 includes ALU circuitry 330, in this example, which may be configured to perform various arithmetic operations as described above.

Sequence detector circuitry 320, in some embodiments, receives a set of instructions and analyzes the instructions to detect the presence of one or more sequences. Circuitry 320 may be configured to detect a single sequence in a set of instructions (e.g., the first discovered sequence pattern) or multiple sequences in the same set of instructions. Circuitry 320 may be configured to detect a single sequence pattern of instructions or multiple different sequence patterns of instructions. In response to detecting one or more sequences, circuitry 320 is configured to provide the relevant program counter(s), operation(s), and immediate value(s) to prefetch circuitry 110. Prefetch circuitry 110 may request prefetches for provided sequences as discussed above.

In some embodiments, detector circuitry 320 is configured to analyze sets of instructions that correspond to instruction cache line fills. This may allow for early data prefetching for detected sequences, e.g., even before instructions in the sequence are fetched from the instruction cache for execution. In some embodiments, the early data prefetch may be based on a fill for a prefetch to the instruction cache (which may be itself be speculative), and therefore may prefetch data prior to execution of a speculative path by the processor. Sequence detector circuitry 320 may also analyze sets of instructions in other scenarios, e.g., when a set of instructions is fetched from the instruction cache, etc.

In some embodiments, detector circuitry 320 performs a multi-pass scan technique. For example, detector circuitry may first scan instructions for one or more starting instructions (e.g., scan for ADRP, ADR, and LDR, in some embodiments, as example instructions that start three different patterns ADRP/ADD/LD, ADR/LD, LDR). In response to detecting a starting instruction, circuitry 320 may scan following instructions to determine if a full pattern is present (e.g., in response to detecting an ADRP, circuitry 320 may determine whether the next two instructions are an ADD and LDR, to detect the pattern of FIG. 2). In some embodiments, detector circuitry 320 provides signaling to prefetch circuitry 110 that indicates the detected pattern(s), which may allow prefetch circuitry 110 to perform the correct arithmetic operations specified by the pattern, properly route operands to ALU circuitry, etc.

ALU circuitry 330 may be dedicated for prefetch operations and therefore may not perform ALU operations for non-prefetch purposes. In other embodiments, ALU circuitry 330 may be shared for other types of operations. ALU circuitry 330 may include adder circuitry implemented using various topologies, e.g., carry lookahead, carry select, carry save, etc. ALU circuitry 330 may also implement other types of arithmetic circuitry such as multiplier circuitry, shift circuitry, etc., which also may be implemented using various appropriate topologies and underlying circuitry. Therefore, disclosed PC-relative prefetch techniques may utilize various types of operations to determine a prefetch address based on a program counter and one or more immediate values in one or more instructions.

In some embodiments, prefetch circuitry 110 includes control circuitry (e.g., multiplexers) configured to route inputs to ALU circuitry 330, e.g., based on control signaling that indicates the detected pattern. This may allow use of at least some of the same ALU circuitry for different patterns of instructions.

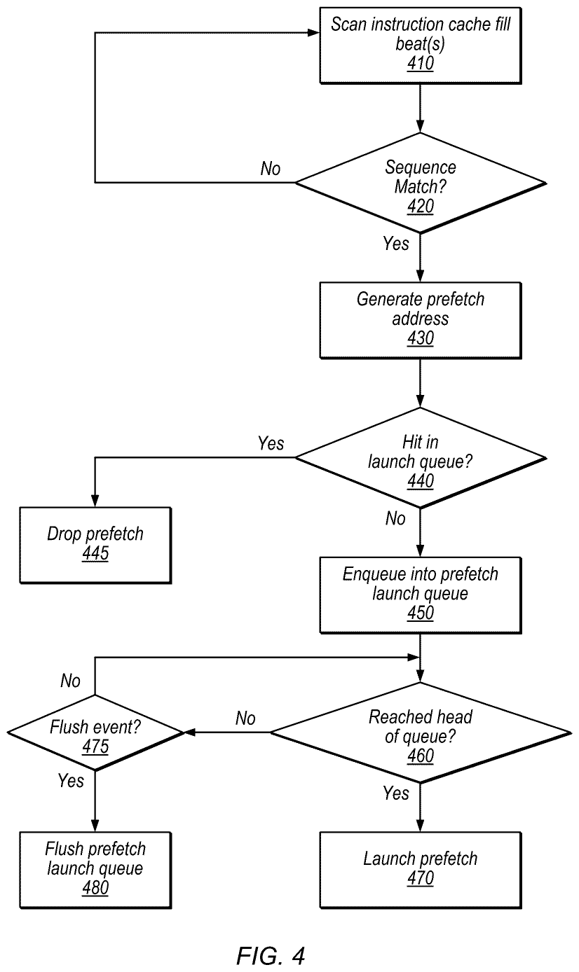

FIG. 4 is a flow diagram illustrating example techniques for scanning sequences of instructions and determining when to launch a prefetch, according to some embodiments. At 410, in the illustrated example, detector circuitry 320 scans one or more instruction cache fill beats. In embodiment with multiple cache fill beats, detector circuitry 320 may include internal storage to store filled instructions and detect sequences that cross beats (or may not be configured to detect sequences that cross beats, in other embodiments).

At 420, detector circuitry 320 determines whether there is a sequence match. If not, flow proceeds back to 410. If there is a match at 420, flow proceeds to 430 and prefetch circuitry 110 generates a prefetch address.

At 440, in the illustrated example, control circuitry determines whether there is a hit in a launch queue (e.g., another prefetch to the same location). The launch queue may store previously generated prefetch requests before launch, until completed, and/or indefinitely (e.g., until overwritten). The launch queue may implement a number of entries accessed using a read index pointer and a write index pointer. Checking for a hit in the launch queue may prevent launching multiple prefetch requests to the same location. If there is a hit in the launch queue, the prefetch is dropped at 445. If there is not a hit, flow proceeds to 450 and the control circuitry enqueues the prefetch request into the launch queue.

If the prefetch request reaches the head of the launch queue at 460, the control circuitry launches the prefetch at 470 (e.g., sends the prefetch to load/store unit circuitry). Otherwise, if a flush event occurs at 475, the control circuitry flushes the prefetch launch queue at 480. Examples of flush events may include a flush command, a privilege level change, a guarded transition, etc. Flushes the launch queue may include writing all addresses to 0×0 and resetting the read and write pointer, for example.

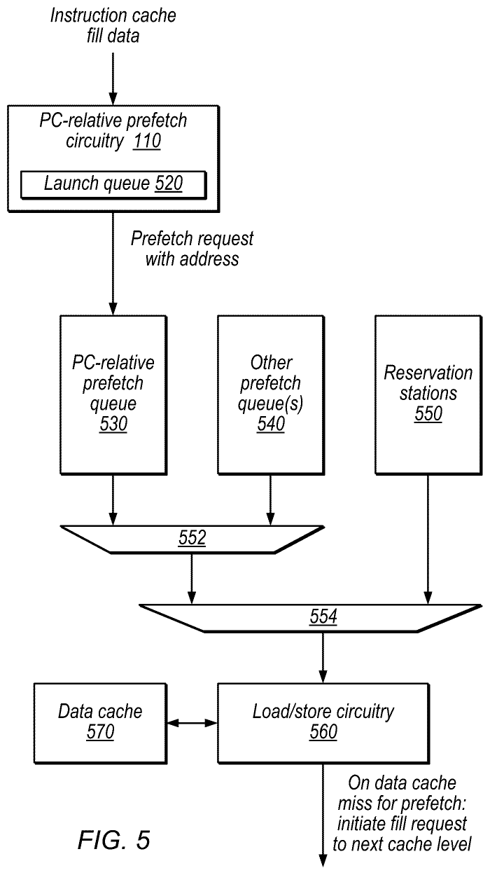

FIG. 5 is a block diagram illustrating example prefetch queue circuitry and load/store circuitry configured to handle prefetch requests initiated by the PC-relative prefetcher. In the illustrated example, a processor includes PC-relative prefetch circuitry 110, PC-relative prefetch queue 530, other prefetch queue(s) 540, reservation stations 550, multiplexer circuitry 552 and 554, load/store circuitry 560, and data cache 570.

Launch queue 520, in the illustrated example, is included in prefetch circuitry 110 and is configured to filter for duplicate prefetch requests, as discussed above.

PC-relative prefetch queue 530, in some embodiments, stores prefetches that have been launched from launch queue 520. In some embodiments, prefetch queue 530 and launch queue 520 implement a credit mechanism to ensure that launch queue 520 sends prefetch requests only when prefetch queue 530 has available entries to store the requests. For example, credit circuitry may include a counter that counts in one direction each time a prefetch request is sent to the launch queue and counts in the other direction based on signaling from the prefetch queue that indicates the prefetch queue 530 has vacated an entry.

Other prefetch queue(s) 540, in some embodiments, store prefetches generated by other prefetch circuitry (e.g., address map pattern matching prefetchers). In other embodiments, PC-relative-based prefetches and one or more other types of prefetches may be stored in the same prefetch queue. In these embodiments, arbitration circuitry may arbitrate between different prefetchers when multiple prefetchers want to add to the prefetch queue in a given cycle. Reservation stations 550 may generate addresses for load operations, e.g., when an instruction is ready to dispatch, according to well-understood pipeline techniques.

Load/store circuitry 560 receives prefetch operations, load operations, and store operations based on selections by the illustrated multiplexer circuitry. Arbitration circuitry may control the multiplexer circuitry, e.g., to prioritize certain types of prefetches over others, to prioritize non-speculative load/store operations over prefetches, or some combination thereof.

Load/store circuitry 560 may also implement internal load/store queues, e.g., to properly handle data hazards, forward store data to loads, etc. For prefetch requests, load/store circuitry 560 is configured to check data cache 570 (e.g., by checking for matching tags) to determine whether the prefetch data is already present in data cache 570. If not, load/store circuitry is configured to initiate a fill request to the next cache level to prefetch the data into the data cache 570. Load/store circuitry 560 may also perform similar checks to load queues, store queues, or both. In this manner, when a detected instruction sequence is eventually executed, the prefetched data is available in data cache 570, which may improve performance, reduce power consumption, or both, relative to retrieving the data from the next cache level when the sequence is executed.

In some embodiments, various disclosed operations are pipelined. For example, one or more instruction cache fill pipeline stages may decode instructions, perform PC-relative prefetch ALU operations, access a content-addressable-memory (CAM) portion of the launch queue to check for duplicate requests, and write to the launch queue (e.g., 520). One or more prefetch pipeline stages may receive the determined prefetch address and handle writing to the prefetch queue (e.g., 530), potentially including credit transactions, a translation lookaside buffer (TLB) lookup, and sending a prefetch request payload. One or more load-store unit stages may handle launching the prefetch.

### Example Method

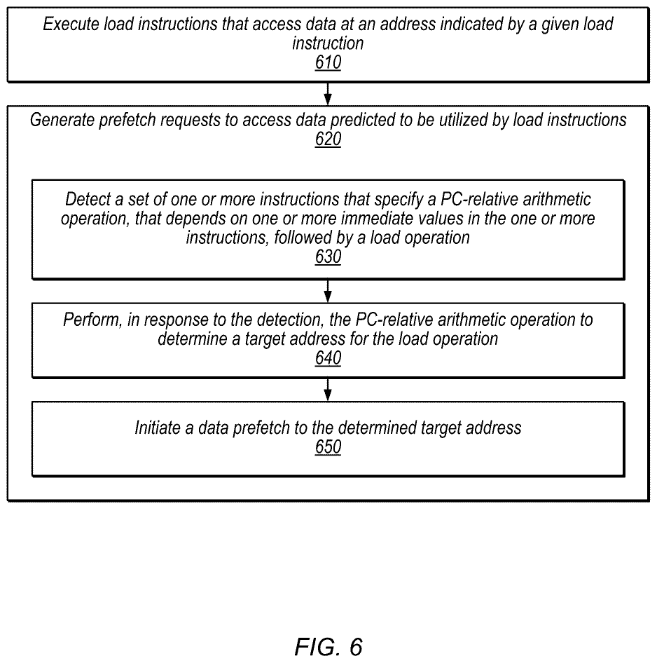

FIG. 6 is a flow diagram illustrating an example method for PC-relative-based prefetching, according to some embodiments. The method shown in FIG. 6 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 610, in the illustrated embodiment, processor circuitry executes load instructions that access data at an address indicated by a given load instruction.

At 620, in the illustrated embodiment, prefetch circuitry generates prefetch requests to access data predicted to be utilized by load instructions. In the illustrated example, this includes elements 630-650.

At 630, in the illustrated embodiment, the prefetch circuitry detects a set of one or more instructions that specify a PC-relative arithmetic operation, that depends on one or more immediate values in the one or more instructions, followed by a load operation. Note that the set of one or more instructions could be a single LDR instruction, for example.

In some embodiments, the detection includes detecting a multiple-instruction pattern that specifies the PC-relative arithmetic operation and the load operation. The prefetch circuitry may perform the PC-relative arithmetic operation and initiate the data prefetch in response to detection of the pattern. In some embodiments, the detection is a multi-pass scan that includes scanning a group of instructions for a starting instruction of the pattern and, in response to detection of the starting instruction, scanning instructions following the starting instruction for remaining instructions of the pattern.

In some embodiments, the detection is performed within a set of instructions for a fill operation to the instruction cache (e.g., from memory or a cache at another level). In some embodiments, the detection is performed across multiple beats of instructions for the fill operation and includes storing state information relating to one or more non-final beats of the beats of instructions. In some embodiments, the prefetch circuitry is configured to perform the detection, PC-relative arithmetic operation, and initiation of a data prefetch for multiple multiple-instruction pattens within the set of instructions for the fill operation.

At 640, in the illustrated embodiment, the prefetch circuitry performs, in response to the detection, the PC-relative arithmetic operation to determine a target address for the load operation. In some embodiments, the prefetch circuitry includes a single-cycle adder dedicated to perform the PC-relative arithmetic operation for prefetches.

At 650, in the illustrated embodiment, the prefetch circuitry initiates a data prefetch to the determined target address. In some embodiments, the prefetch circuitry may check that the determined address is not already resident in a prefetch queue prior to initiating the data prefetch to the determined address. Further, load circuitry (e.g., in a load-store unit) may check for a hit in a data cache prior to performing the data prefetch to the determined address, where the data prefetch is into the data cache.

In some embodiments, to initiate the data prefetch to the determined address, the prefetch circuitry is configured to send a prefetch request to a prefetch queue. The prefetch circuitry may flush the prefetch queue in response to one or more flush events. The system may include credit circuitry configured to implement a credit mechanism to determine whether the prefetch queue is in a state that allows acceptance of the prefetch request.

In some embodiments, (e.g., in embodiments where the prefetch is based on a fill into the instruction cache) circuitry may perform the data prefetch prior to fetch of the load operation from the instruction cache.

In some embodiments, the prefetch circuitry may perform PC-relative operations to prefetch instructions for a branch. For example, the prefetch circuitry may detect a set of one or more instructions that specify a PC-relative arithmetic operation, that depends on one or more immediate values in the one or more instructions, followed by a branch operation. In response to the detection, the prefetch circuitry may perform the PC-relative arithmetic operation to determine an address for the branch operation and initiate an instruction prefetch to the determined address. Note that pre-fetching data for a load operation and pre-prefetching instructions for a branch target are different in various aspects; some embodiments may implement PC-relative data prefetching but not PC-relative branch prefetching and vice versa while other embodiments may implement both.

The concept of “execution” is broad and may refer to 1) processing of an instruction throughout an execution pipeline (e.g., through fetch, decode, execute, and retire stages) and 2) processing of an instruction at an execution unit or execution subsystem of such a pipeline (e.g., an integer execution unit or a load-store unit). The latter meaning may also be referred to as “performing” the instruction. Thus, “performing” an add instruction refers to adding two operands to produce a result, which may, in some embodiments, be accomplished by a circuit at an execute stage of a pipeline (e.g., an execution unit). Conversely, “executing” the add instruction may refer to the entirety of operations that occur throughout the pipeline as a result of the add instruction. Similarly, “performing” a “load” instruction may include retrieving a value (e.g., from a cache, memory, or stored result of another instruction) and storing the retrieved value into a register or other location.

As used herein the terms “complete” and “completion” in the context of an instruction refer to commitment of the instruction's result(s) to the architectural state of a processor or processing element. For example, completion of an add instruction includes writing the result of the add instruction to a destination register. Similarly, completion of a load instruction includes writing a value (e.g., a value retrieved from a cache or memory) to a destination register or a representation thereof.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

For a given program or portion of a program, flow typically proceeds in a sequential fashion. Consider the following group of instructions: ld mem1→r1; add r1, r2→r3; st r3→mem2. In this exemplary sequence, execution and completion proceeds sequentially from the load instruction to the add instruction to the store instruction. This sequential ordering can be considered the program flow default. In this example, none of these instructions affects the selection of the next instruction to be executed and completed (beyond the default behavior).

In contrast, the execution and completion of instructions with certain opcodes potentially affects the selection of the next instruction to be executed and completed. These instructions are referred to herein as “control transfer instructions.” Control transfer instructions may include, without limitation, branches, jumps, calls, returns, etc. Instructions of these types can cause a change in the default behavior of the next instruction to be executed and completed. Control transfer instructions may be used, for example, to execute a loop of instructions.

There may also be many different types of control transfer instructions. For example, control transfer instructions may operate conditionally (i.e., setting the program counter based on whether some condition is true or false) or unconditionally. Similarly, certain control transfer instructions may specify direct target addresses; other control transfer instructions may specify indirect target addresses. Note that the execution and completion of control transfer instructions may have effects on processor state other than on the location of the next instruction (e.g., there might be an instruction that branches after performing an arithmetic operation).

### Example Device

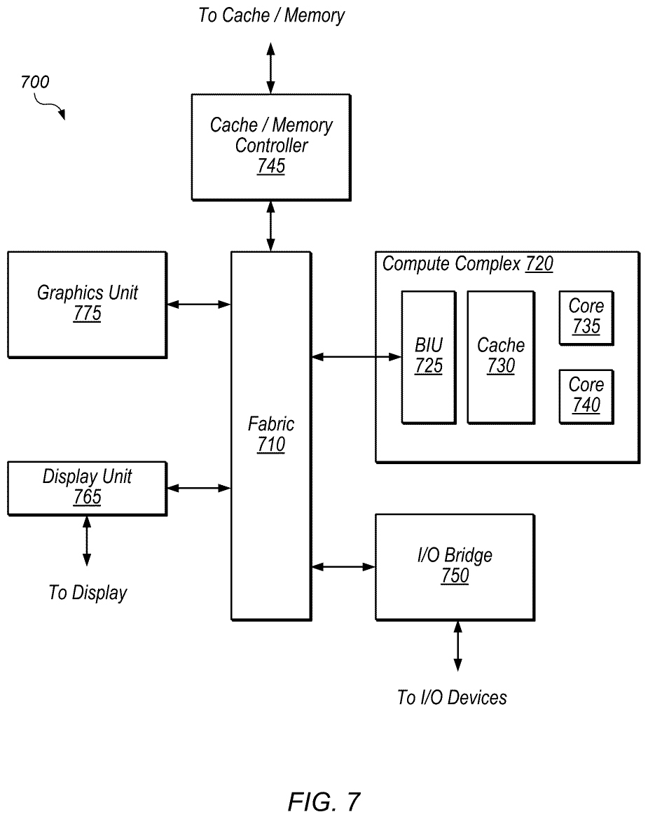

Referring now to FIG. 7, a block diagram illustrating an example embodiment of a device 700 is shown. In some embodiments, elements of device 700 may be included within a system on a chip. In some embodiments, device 700 may be included in a mobile device, which may be battery-powered. Therefore, power consumption by device 700 may be an important design consideration. In the illustrated embodiment, device 700 includes fabric 710, compute complex 720 input/output (I/O) bridge 750, cache/memory controller 745, graphics unit 775, and display unit 765. In some embodiments, device 700 may include other components (not shown) in addition to or in place of the illustrated components, such as video processor encoders and decoders, image processing or recognition elements, computer vision elements, etc.

Fabric 710 may include various interconnects, buses, MUX's, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and caches. For example, compute complex 720 may include 1, 2, or 4 processor cores, or any other suitable number. In one embodiment, cache 730 is a set associative L2 cache. In some embodiments, cores 735 and 740 may include internal instruction and data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions. These instructions may be stored in computer readable medium such as a memory coupled to memory controller 745 discussed below.

In some embodiments, disclosed techniques may be used to prefetch for one or more cores, e.g., 735 and 740. Disclosed prefetch techniques may improve performance, reduce power consumption, or both, relative to traditional prefetch techniques.

As used herein, the term “coupled to” may indicate one or more connections between elements, and a coupling may include intervening elements. For example, in FIG. 7, graphics unit 775 may be described as “coupled to” a memory through fabric 710 and cache/memory controller 745. In contrast, in the illustrated embodiment of FIG. 7, graphics unit 775 is “directly coupled” to fabric 710 because there are no intervening elements.

Cache/memory controller 745 may be configured to manage transfer of data between fabric 710 and one or more caches and memories. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches. Memory coupled to controller 745 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 745 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 720 to cause the computing device to perform functionality described herein.

Graphics unit 775 may include one or more processors, e.g., one or more graphics processing units (GPUs). Graphics unit 775 may receive graphics-oriented instructions, such as VULKAN®, Metal®, or DIRECTX® instructions, for example. Graphics unit 775 may execute specialized GPU instructions or perform other operations based on the received graphics-oriented instructions. Graphics unit 775 may generally be configured to process large blocks of data in parallel and may build images in a frame buffer for output to a display, which may be included in the device or may be a separate device. Graphics unit 775 may include transform, lighting, triangle, and rendering engines in one or more graphics processing pipelines. Graphics unit 775 may output pixel information for display images. Graphics unit 775, in various embodiments, may include programmable shader circuitry which may include highly parallel execution cores configured to execute graphics programs, which may include pixel tasks, vertex tasks, and compute tasks (which may or may not be graphics-related).

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and low-power always-on functionality, for example. I/O bridge 750 may also include interfaces such as pulse-width modulation (PWM), general-purpose input/output (GPIO), serial peripheral interface (SPI), and inter-integrated circuit (I2C), for example. Various types of peripherals and devices may be coupled to device 700 via I/O bridge 750.

In some embodiments, device 700 includes network interface circuitry (not explicitly shown), which may be connected to fabric 710 or I/O bridge 750. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 700 with connectivity to various types of other devices and networks.

### Example Applications

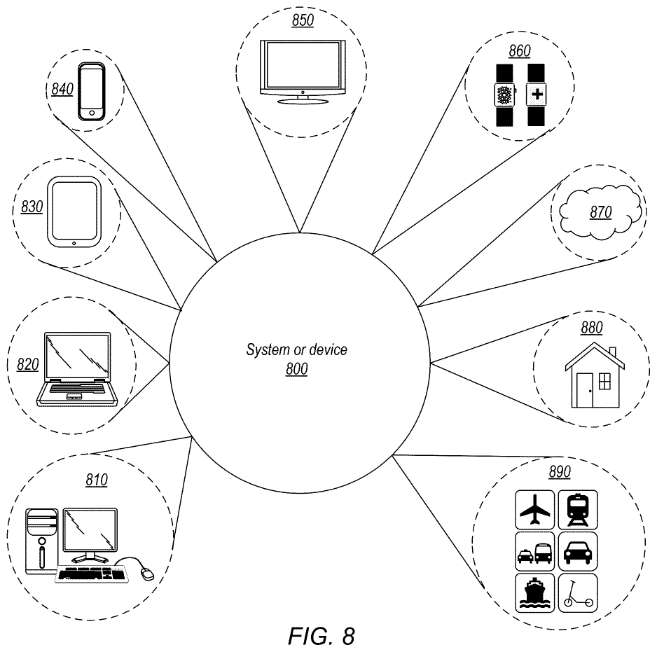

Turning now to FIG. 8, various types of systems that may include any of the circuits, devices, or system discussed above. System or device 800, which may incorporate or otherwise utilize one or more of the techniques described herein, may be utilized in a wide range of areas. For example, system or device 800 may be utilized as part of the hardware of systems such as a desktop computer 810, laptop computer 820, tablet computer 830, cellular or mobile phone 840, or television 850 (or set-top box coupled to a television).

Similarly, disclosed elements may be utilized in a wearable device 860, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 800 may also be used in various other contexts. For example, system or device 800 may be utilized in the context of a server computer system, such as a dedicated server or on shared hardware that implements a cloud-based service 870. Still further, system or device 800 may be implemented in a wide range of specialized everyday devices, including devices 880 commonly found in the home such as refrigerators, thermostats, security cameras, etc. The interconnection of such devices is often referred to as the “Internet of Things” (IoT). Elements may also be implemented in various modes of transportation. For example, system or device 800 could be employed in the control systems, guidance systems, entertainment systems, etc. of various types of vehicles 890.

The applications illustrated in FIG. 8 are merely exemplary and are not intended to limit the potential future applications of disclosed systems or devices. Other example applications include, without limitation: portable gaming devices, music players, data storage devices, unmanned aerial vehicles, etc.

### Example Computer-readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

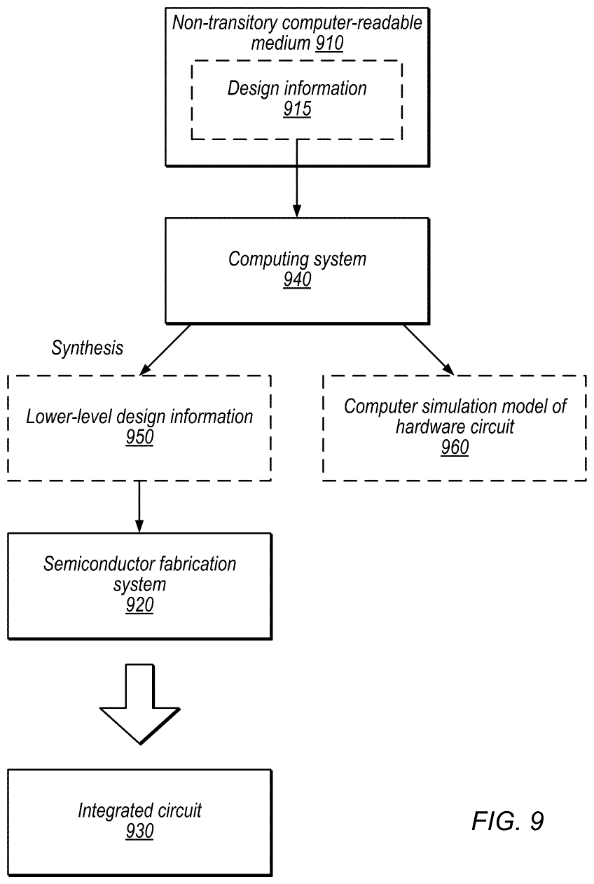

FIG. 9 is a block diagram illustrating an example non-transitory computer-readable storage medium that stores circuit design information, according to some embodiments. In the illustrated embodiment, computing system 940 is configured to process the design information. This may include executing instructions included in the design information, interpreting instructions included in the design information, compiling, transforming, or otherwise updating the design information, etc. Therefore, the design information controls computing system 940 (e.g., by programming computing system 940) to perform various operations discussed below, in some embodiments.

In the illustrated example, computing system 940 processes the design information to generate both a computer simulation model of a hardware circuit 960 and lower-level design information 950. In other embodiments, computing system 940 may generate only one of these outputs, may generate other outputs based on the design information, or both. Regarding the computing simulation, computing system 940 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 940 also processes the design information to generate lower-level design information 950 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 950 (potentially among other inputs), semiconductor fabrication system 920 is configured to fabricate an integrated circuit 930 (which may correspond to functionality of the simulation model 960). Note that computing system 940 may generate different simulation models based on design information at various levels of description, including information 950, 915, and so on. The data representing design information 950 and model 960 may be stored on medium 910 or on one or more other media.

In some embodiments, the lower-level design information 950 controls (e.g., programs) the semiconductor fabrication system 920 to fabricate the integrated circuit 930. Thus, when processed by the fabrication system, the design information may program the fabrication system to fabricate a circuit that includes various circuitry disclosed herein.

Non-transitory computer-readable storage medium 910, may comprise any of various appropriate types of memory devices or storage devices. Non-transitory computer-readable storage medium 910 may be an installation medium, e.g., a CD-ROM, floppy disks, or tape device; a computer system memory or random access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. Non-transitory computer-readable storage medium 910 may include other types of non-transitory memory as well or combinations thereof. Accordingly, non-transitory computer-readable storage medium 910 may include two or more memory media; such media may reside in different locations—for example, in different computer systems that are connected over a network.

Design information 915 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 940, semiconductor fabrication system 920, or both. In some embodiments, design information may also include one or more cell libraries that specify the synthesis, layout, or both of integrated circuit 930. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 930 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 920 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 920 may also be configured to perform various testing of fabricated circuits for correct operation.

In various embodiments, integrated circuit 930 and model 960 are configured to operate according to a circuit design specified by design information 915, which may include performing any of the functionality described herein. For example, integrated circuit 930 may include any of various elements shown in FIGS. 1, 3, 5, and 7. Further, integrated circuit 930 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 920 to fabricate integrated circuit 930.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
processor circuitry configured to execute load instructions that access data at an address indicated by a given load instruction;
prefetch circuitry configured to generate prefetch requests to access data predicted to be utilized by load instructions, including to:
detect a set of one or more instructions that specify a PC-relative arithmetic operation, that depends on one or more immediate values in the one or more instructions, followed by a load operation;
in response to the detection, perform the PC-relative arithmetic operation to determine a target address for the load operation; and
initiate a data prefetch to the determined target address.

2. The apparatus of claim 1, wherein the detection includes to:
detect a multiple-instruction pattern that specifies the PC-relative arithmetic operation and the load operation; and
wherein the prefetch circuitry is configured to perform the PC-relative arithmetic operation and initiate the data prefetch in response to detection of the pattern.

3. The apparatus of claim 2, wherein the detection includes to:
scan a group of instructions for a starting instruction of the pattern; and
in response to detection of the starting instruction, scan instructions following the starting instruction for remaining instructions of the pattern.

4. The apparatus of claim 2, further comprising:
an instruction cache;
wherein the detection is performed within a set of instructions for a fill operation to the instruction cache.

5. The apparatus of claim 4, wherein the detection is performed across multiple beats of instructions for the fill operation and includes to store state information relating to one or more non-final beats of the beats of instructions.

6. The apparatus of claim 4, wherein the prefetch circuitry is configured to perform the detection, PC-relative arithmetic operation, and initiation of a data prefetch for multiple multiple-instruction pattens within the set of instructions for the fill operation.

7. The apparatus of claim 1, wherein the prefetch circuitry is further configured to:
detect a set of one or more instructions that specify a PC-relative arithmetic operation, that depends on one or more immediate values in the one or more instructions, followed by a branch operation;
perform the PC-relative arithmetic operation to determine an address for the branch operation; and
initiate an instruction prefetch to the determined address.

8. The apparatus of claim 1, wherein the prefetch circuitry is further configured to:
check that the determined address is not already resident in a prefetch queue prior to initiating the data prefetch to the determined address.

9. The apparatus of claim 8, further comprising:
load circuitry configured to check for a hit in a data cache prior to performing the data prefetch to the determined address, wherein the data prefetch is into the data cache.

10. The apparatus of claim 1, further comprising:
circuitry configured to perform the data prefetch prior to fetch of the load operation from an instruction cache.

11. The apparatus of claim 1, wherein the prefetch circuitry includes a single-cycle adder dedicated to perform the PC-relative arithmetic operation for prefetches.

12. The apparatus of claim 1, wherein:
to initiate the data prefetch to the determined address, the prefetch circuitry is configured to send a prefetch request to a prefetch queue; and
the prefetch circuitry is configured to flush the prefetch queue in response to one or more flush events.

13. The apparatus of claim 12, wherein the apparatus further includes credit circuitry configured to implement a credit mechanism to determine whether the prefetch queue is in a state that allows acceptance of the prefetch request.

14. The apparatus of claim 1, wherein the apparatus is a computing device that further comprises:
a display;
a central processing unit; and
a network interface.

15. A method, comprising:
executing, by a computing system, load instructions that access data at an address indicated by a given load instruction;
generating, by the computing system, prefetch requests to access data predicted to be utilized by load instructions, including:
detecting a set of one or more instructions that specify a PC-relative arithmetic operation, that depends on one or more immediate values in the one or more instructions, followed by a load operation;
in response to the detection, performing the PC-relative arithmetic operation to determine a target address for the load operation; and
initiating a data prefetch to the determined target address.

16. The method of claim 15, wherein the detecting includes detecting a multiple-instruction pattern that specifies the PC-relative arithmetic operation and the load operation.

17. The method of claim 15, wherein the detecting is performed within a set of instructions for a fill operation to an instruction cache.

18. The method of claim 15, further comprising:
checking for a hit in a data cache prior to performing the data prefetch to the determined address, wherein the data prefetch is into the data cache.

19. The method of claim 15, wherein the initiating is performed prior to fetch of the load operation from an instruction cache.

20. A non-transitory computer-readable medium having instructions of a hardware description programming language stored thereon that, when processed by a computing system, program the computing system to generate a computer simulation model, wherein the model represents a hardware circuit that includes:
processor circuitry configured to execute load instructions that access data at an address indicated by a given load instruction;
prefetch circuitry configured to generate prefetch requests to access data predicted to be utilized by load instructions, including to:
detect a set of one or more instructions that specify a PC-relative arithmetic operation, that depends on one or more immediate values in the one or more instructions, followed by a load operation;
in response to the detection, perform the PC-relative arithmetic operation to determine a target address for the load operation; and
initiate a data prefetch to the determined target address.
